(19) United States
(12) Patent Application Publication
(10) Pub. No.: US 2008/0244347 A1
(43) Pub. Date: Oct. 2, 2008

(54) Automated Circuit Model Generator

(76) Inventor: Rory L. Fisher, Fort Collins, CO (US)

Correspondence Address: Kathy Manke;Avago Technologies Limited, 4380 Ziegler Road, Fort Collins, CO, 80525, US

(21) Appl. No.: 11/692,601

(22) Filed: Mar. 28, 2007

(51) Int. Cl. G06F 11/00

(52) U.S. Cl. 714/741

(57) ABSTRACT

A method, system and program reduce ATPG processing times by eliminating non-value added cells in a circuit model that that is provided to an ATPG system. The elimination of non-value added cells results in a logically equivalent circuit model that is reduced in size from an original circuit model. As a result, an ATPG system that receives the modified circuit model generates a set of test vectors in a shorter amount of time. The method, system and program identify select cells in accordance with information provided in an original circuit model that defines each of the separate circuit cells. Leaf cells, a specific type of cell, are processed using a first set of conditions to generate a modified cell definition. Thereafter, a second set of conditions are applied to generate a modified circuit model.

### BACKGROUND

Integrated circuits and other semiconductor and electronic products are routinely tested to ensure that they function properly before a product containing the device under test (DUT) is shipped, sold, or placed into use. Automatic test pattern generation (ATPG) systems are used to generate a set of test patterns that will test for and detect faults on the tested device. ATPG systems use a model of a device to formulate the test patterns, test vectors, etc. that may be used by automatic testing equipment (ATE) to test the DUT.

A variety of automatic test equipment (ATE) have long been known for testing electronic circuits, devices, integrated circuits, and other semiconductor and electronic products. Generally, automatic test equipment is divided into two broad categories, analog testers and digital testers. As the names imply, analog testers are generally designed for testing analog circuit devices, while digital testers are designed for testing digital circuit devices. Digital testers generally include a testing device having a number of internal circuit cards or channels that generate programmably controlled test signals for testing and evaluating a DUT. More specifically, ATE may be programmably controlled to be adapted or configured to test a variety of devices in a variety of ways. This is achieved by programming ATE inputs to inject a certain signal (or signal transition) and by programming ATE outputs to compare a value to a certain pin or signal line on a DUT. In this regard, a digital tester generally includes a test head by which electrical signals are input to and output from the tester. The test head comprises a number of connectors, each defining a channel, which may be connected via cable or otherwise to a device under test. The electronics within the digital tester may then input and output signals to/from a DUT via the test head.

By way of an extremely simple illustration, consider a digital tester that is configured to test a package containing, among other things, a two input AND gate. The digital tester may be configured to apply a logic one on the two signal lines that correspond to the inputs of the AND gate, then receive the signal on the signal line corresponding to the output to ensure that it is driven to a logic one in response. The tester may then be configured to alternatively apply logic zero signals on each of the two signal lines corresponding to the AND gate inputs, in order to verify that the output of the AND gate transitions from a logic one to a logic zero in response. If proper (i.e., expected) operation is not realized, then a defect is detected.

An integrated circuit tester includes a set of channels or “nodes.” Each node is associated with each terminal of the DUT. When the DUT is an integrated circuit chip (IC) chip, then one channel may be associated with each pin of the IC chip. A test is organized into a set of successive time segments or test cycles. During any given test cycle, each channel can either transmit a test signal to the pin, sample a DUT output signal at the associated pin, or do neither. Each channel includes its own memory for storing a sequence of these transmit or sample commands more commonly known as test vectors.

As known in the art, an ATPG system is independent and distinct from a tester. An ATPG system uses a model of a DUT to formulate a set of test vectors that will test for and detect faults on the tested device. Thereafter, a tester receives a set of test vectors from the ATPG system and applies the test vectors to test the actual device.

Existing ATPG solutions, however, are problematic due to the amount of processing time, resources, etc. required to generate a set of test vectors for large scale application specific integrated circuits (ASICs). Long ATPG runtimes result from the processing times required to generate transition-fault patterns from models of the ASIC to be tested. For large ASIC designs, it can take many days for ATPG tools to generate a set of test vectors.

Thus, improvements in test vector generation are required, specifically in the development of systems and methods that enable improved efficiencies in the time required to generate a set of test vectors.

### SUMMARY

The present systems and methods reduce ATPG processing times by eliminating non-value added cells in the ASIC design that is provided to the ATPG. The elimination of non-value added cells results in a logically equivalent ASIC model that is reduced in size from an original ASIC model. As a result, an ATPG system that receives the modified circuit model generates a set of test vectors in a shorter amount of time.

An embodiment comprises a method for analyzing a model of a circuit. Briefly described, one such method comprises the steps of selecting a cell from a circuit model to identify a cell under test, the cell under test including information that defines the cell under test, identifying when the information indicates that the cell under test is a leaf cell, when the cell under test is a leaf cell applying a first set of conditional modifications to generate a modified cell definition and recursively applying a second set of conditional modifications to generate a modified circuit model responsive to the modified cell definition.

Another embodiment comprises a program embodied in a computer-readable medium for analyzing a model of a circuit. Briefly described, one such program comprises logic configured to select a cell from a circuit model to identify a cell under test, the cell under test including information that defines the cell under test, logic configured to identify when the information indicates that the cell under test is a leaf cell, when the cell under test is a leaf cell branching to logic configured to apply a first set of conditional modifications to generate a modified cell definition and recursive logic configured to apply a second set of conditional modifications to generate a modified circuit model.

Another embodiment comprises a circuit model generation system. Briefly described, one such circuit model generation system comprises a memory and a processor. The memory contains a hierarchical model of a circuit divided into cells. The processor executes logic that selects a cell from the circuit model, identifies when the information indicates that the cell is a leaf cell and applies a first set of conditional modifications to generate a modified cell definition. The processor also executes logic that applies a second set of conditional modifications to generate a modified circuit model.

Other systems, methods, features and advantages will be or will become apparent to one skilled in the art upon examination of the following figures and detailed description of the automated circuit model generator. All such additional systems, methods, features and advantages are defined and protected by the accompanying claims.

### BRIEF DESCRIPTION OF THE DRAWINGS

The present methods, programs and systems for analyzing and modifying a circuit model, as defined in the claims, can be better understood with reference to the following drawings. The components within the drawings are not necessarily to scale relative to each other; emphasis instead is placed upon clearly illustrating the principles for analyzing and modifying circuit models before applying the circuit model to an ATPG system.

FIG. 1 is a functional block diagram illustrating an embodiment of a system for generating a modified circuit model.

FIG. 2 is a flow diagram illustrating an embodiment of a method for analyzing and modifying a circuit model that can be executed by the circuit model generation system of FIG. 1.

FIG. 3 is a functional block diagram illustrating an embodiment of the circuit model generation system of FIG. 1.

FIGS. 4A and 4B are schematic diagrams illustrating example embodiments of a cell-level circuit model and a modified cell-level circuit model.

FIG. 5 is schematic diagram illustrating an example embodiment of a second cell-level circuit model.

FIGS. 6A and 6B are schematic diagrams illustrating example embodiments of a third cell-level circuit model and a modified cell-level circuit model.

FIGS. 7A and 7B are schematic diagrams illustrating example embodiments of a fourth cell-level circuit model and a modified cell-level circuit model.

FIGS. 8A and 8B are schematic diagrams illustrating example embodiments of a fifth cell-level circuit model and a modified cell-level circuit model.

### DETAILED DESCRIPTION

The present systems and methods reduce ATPG processing times by eliminating non-value added cells in the ASIC design that is provided to the ATPG. The elimination of non-value added cells results in a logically equivalent ASIC model that is reduced in size from an original ASIC model. As a result, an ATPG system that receives the modified circuit model generates a set of test vectors in a shorter amount of time.

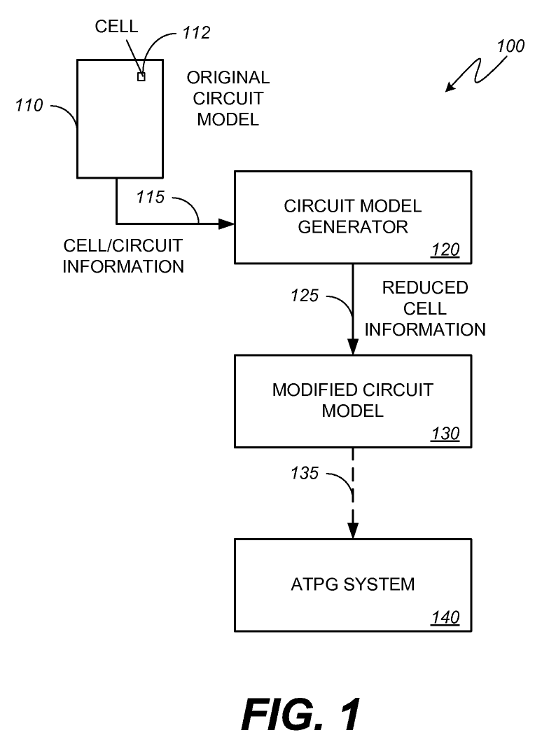

FIG. 1 is a functional block diagram illustrating an embodiment of a system for generating a modified circuit model. System 100 includes circuit model generator 120 and ATPG system 140. Circuit model generator 120 receives cell and circuit information from original circuit model 110 via link 115. Original circuit model 110 includes a plurality of individual circuit cells such as cell 112. The cell and circuit information received are in accordance with an original circuit model, such as a hierarchically arranged netlist description of an integrated circuit. Preferably, the original circuit model is a complete top level description of an integrated circuit with cell designs and information libraries available.

Circuit model generator 120 loads and recursively processes the received cell and circuit connectivity information using sets of conditional rules that reduce the complexity of original circuit model 110 at both cell and circuit levels. Circuit model generator 120 analyzes circuits that traverse cell interfaces and eliminates non-value added elements from the logical model of the integrated circuit. Circuit model generator 120 produces intra-cell or reduced cell information that is a logically equivalent to the corresponding cell information present in original circuit model 110. Circuit model generator 120 forwards the reduced cell information via link 125 to a data storage device configured to store modified circuit model 130.

The modified circuit model 130 is communicated to ATPG system 140 when it is desired to develop a set of test vectors that can be used with test equipment to test the performance and operation of an actual integrated circuit produced in accordance with original circuit model 110. The smaller, though logically equivalent, modified circuit model 130 enables a reduction in the run time it takes for ATPG system 140 to generate test patterns for a large-scale ASIC. An additional benefit of eliminating buffers and generating a reduced netlist is that DFT (defect and fault tolerance) verification runtimes are also reduced as there are fewer cells and supporting information that must be stored and processed.

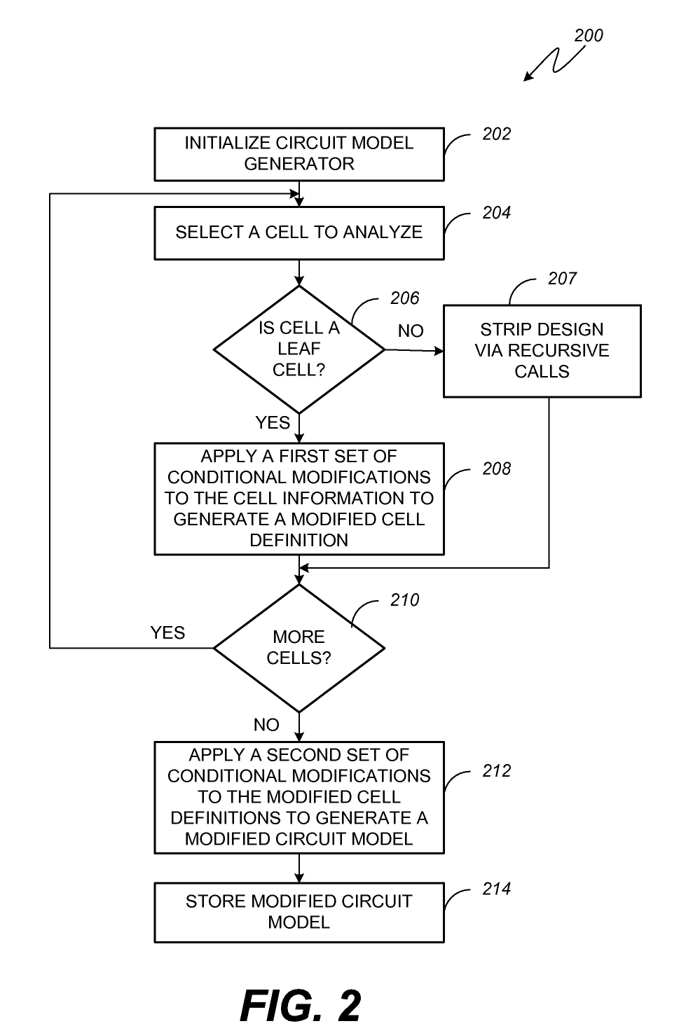

FIG. 2 is a flow diagram illustrating an embodiment of a method for analyzing and modifying a circuit model that can be executed by the circuit model generator 120 of FIG. 1. FIG. 2 is a flow diagram illustrating the architecture, operation, and/or functionality of one of a number of possible embodiments of the circuit model generator 120. In an embodiment, circuit model generator 120 is a computing device that executes logic upon data to enable the illustrated function(s).

The method for analyzing and modifying a circuit model begins with block 202 where the circuit model generator is initialized. Initialization generally includes establishing access to a digital representation of an integrated circuit. In some embodiments, the digital representation is in the form of a hierarchically arranged netlist and supporting libraries. Thereafter, a cell is selected for analysis as indicated in block 204. Selection of a cell for analysis includes gaining access to a corresponding data location or buffering of information that defines the cell. Information that defines the cell will include connectivity at the interface (i.e., inter-cell information) as well as components and nodes inside the cell (i.e., intra-cell information).

Next, a determination is made via query block 206 whether the present cell is a leaf cell. A leaf cell is characterized as a cell that contains digital logic or other transistors (e.g., a buffer, inverter, AND gate, NAND gate, OR gate, NOR gate, etc.) Non-leaf cells do not contain digital logic or transistors. When the present cell is a leaf cell, processing continues with the application of a first set of conditional modifications to the cell information to generate a modified cell definition as shown in block 208. Thereafter, a determination is made in query block 210 whether additional cells are to be analyzed or processed. If so, processing continues with blocks 204 through 210 until all available cells in the circuit model have been processed. Some cell information may describe a circuit that includes a buffer implemented as a chain of series coupled inverters. The modified cell definition not only eliminates standard buffers but also searches for series coupled inverters where the conductor between the inverters is connected only to the input of the second of the two inverters. When such a circuit is identified, the conditional modification will include the removal of both inverters. When it is the case that a circuit contains an odd number of series coupled inverters, the conditional modification will include the elimination of all but one of the inverters (i.e., an even number of inverters) to preserve the polarity of the modeled chain. Otherwise, when the present cell under analysis is not a leaf cell, processing continues with recursive calls to strip the circuit design as shown in block 207.

After the cells have been processed (i.e., reduced by eliminating buffers and connecting nodes) as indicated by the flow control arrow labeled, “NO” exiting decision block 210, the circuit model generator applies a second set of conditional modifications upon the modified cell definitions to generate a modified circuit model as indicated in block 212. Thereafter, as illustrated in block 214, the modified circuit model is stored.

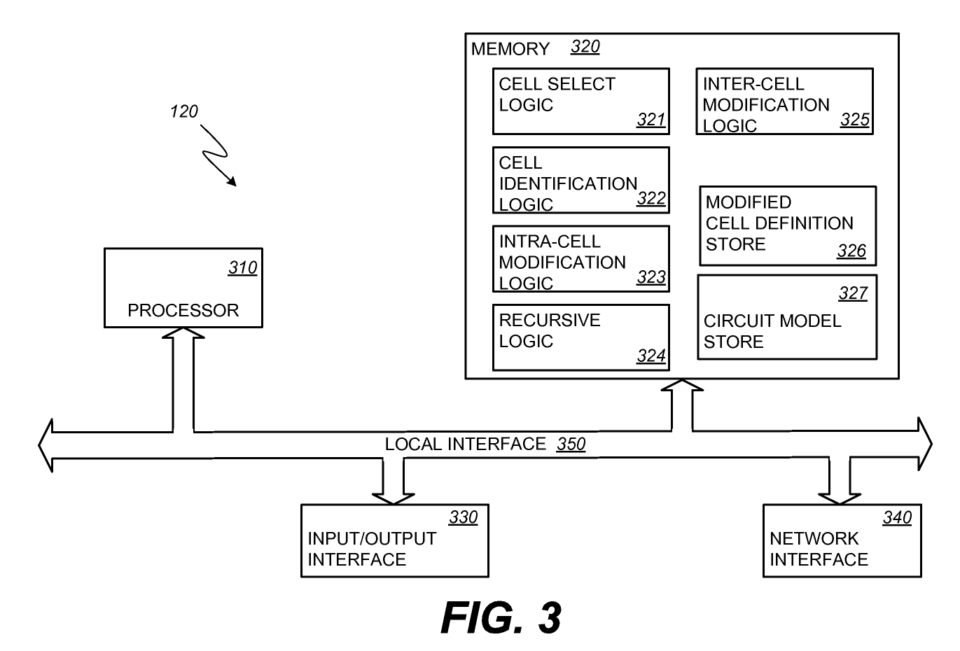

FIG. 3 is a functional block diagram illustrating an embodiment of the circuit model generator 120 of FIG. 1. When the logic used by circuit model generator 120 is implemented in software, as is shown in FIG. 3, it should be noted that one or more of cell select logic 321, cell identification logic 322, intra-cell modification logic 323, recursive logic 324, inter-cell modification logic 325 as well as information in modified cell definition store 326 and circuit model store 327 may be stored on any computer-readable medium for use by or in connection with any computer-related system or method. In the context of this document, a computer-readable medium is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where circuit model generator 120 is implemented in hardware, it may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In terms of hardware architecture, as shown in FIG. 3, circuit model generator 120 includes a processor 310, memory 320, input and/or output (I/O) interface(s) 330, and network interface 340 that are in communication with each other via local interface 350. Local interface 350 can be, for example but not limited to, one or more buses or other wired or wireless connections, as is known in the art. The local interface 350 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 310 is a hardware device for executing software, particularly software stored in memory 320. The processor 310 can be any custom made or commercially available processor, a central processing unit (CPU), an auxiliary processor among several processors associated with circuit model generator 120, a semiconductor based microprocessor (in the form of a microchip or chip set), or generally any device for executing software instructions.

Memory 320 may include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 320 may incorporate electronic, magnetic, optical, and/or other types of storage media. Note that the memory 320 can have a distributed architecture, where various components are situated remote from one another, but can be accessed by the processor 310.

The software in memory 320 may include one or more separate programs, each of which comprises an ordered listing of executable instructions for implementing logical functions. In the example of FIG. 3, the software in the memory 320 includes cell select logic 321, cell identification logic 322, intra-cell modification logic 323, recursive logic 324, inter-cell modification logic 325 as well as information in modified cell definition store 326 and circuit model store 327. Memory 320 will generally include a suitable operating system (O/S) (not shown) and perhaps other application(s) or programs. The operating system essentially controls the execution of other computer programs, such as portions of circuit model generator 120 and provides scheduling, input-output control, file and data management, memory management, and communication control and related services.

Cell select logic 321 accesses and buffers information associated with a specified cell to be analyzed. Cell identification logic 322 determines whether the cell information indicates that the cell is a leaf cell. Intra-cell modification logic 323 includes a set of conditional rules or translations to apply to various combinations of logic elements and connections within a present cell of interest. Recursive logic 324 methodically directs the circuit model generator 120 to process each cell in the hierarchically arranged original circuit model 100 (FIG. 1). Inter-cell modification logic 325 keeps track of conductors that span cell boundaries.

Modified cell definition store 326 holds or buffers information that defines the translated (i.e., reduced) cell models. Circuit model store 327 holds or buffers one or both of the original circuit model 110 (FIG. 1) and the modified circuit model 130 (FIG. 1).

It will be appreciated that functional portions of circuit model generator 120 may be a source program, executable program (object code), script, or any other entity comprising a set of instructions to be performed. When a source program, the program needs to be translated via a compiler, assembler, interpreter, or the like, which may or may not be included within the memory 320, so as to operate properly in connection with an operating system (not shown). Furthermore, portions of circuit model generator 120 may be written in (a) an object oriented programming language, which has classes of data and methods, or (b) a procedure programming language, which has routines, subroutines, and/or functions.

I/O interface(s) 330 may include circuits and buffers for coupling input devices, for example but not limited to, a keyboard, mouse, scanner, microphone, etc. to local interface 350. I/O interface(s) 330 may also include circuits and buffers for coupling output devices, for example but not limited to, a printer, display, etc. to local interface 350.

Network interface 340 may comprise the various components used to transmit and/or receive data over a network. By way of example, the network interface 340 may include a device that can communicate both inputs and outputs, for instance, a modulator/demodulator (e.g., modem), wireless (e.g., radio frequency (RF)) transceiver, a telephonic interface, a bridge, a router, network card, etc.

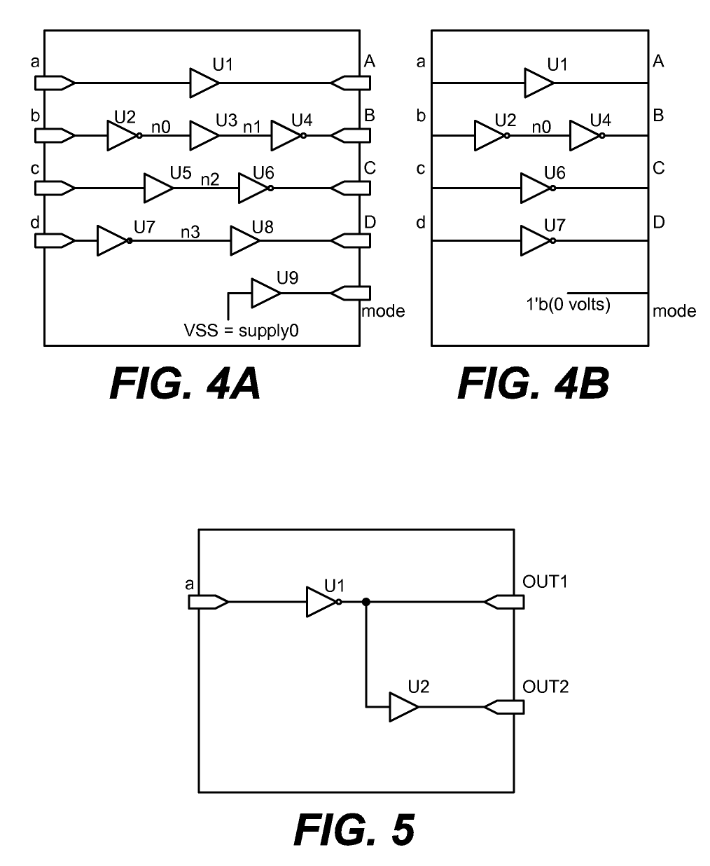

FIGS. 4A-8B illustrate the application of multiple conditional translations or modifications of cell information to generate a modified circuit model that is logically equivalent to the integrated circuit defined by the original circuit model. In this regard, FIGS. 4A and 4B are schematic diagrams illustrating example embodiments of a cell-level circuit model and a modified cell-level circuit model, wherein a number of buffers are eliminated from the cell information. FIG. 4A illustrates an embodiment of a cell supplied with an original circuit model. FIG. 4B illustrates an embodiment of a modified cell. The cell illustrated in FIG. 4A reveals five circuits that traverse the cell boundary that include a buffer.

Buffer U1 represents a condition where both the input and the output of buffer U1 are connected to respective I/O ports of the cell. Buffer U1 is eliminated and information that input port a and output port A are logically equivalent is hashed or stored so when the cell is instantiated correct connections can be generated. However, when the cell is at the top-level of the hierarchical circuit design, two ports with different names will not be tied together as shown in FIG. 4B, consequently buffer U1 is inserted to separate input a from output A.

As shown in FIG. 4A, buffer U3 represents a condition where both the input and the output of buffer U3 are not connected to respective I/O ports of the cell. Buffer U3 and connection n1 are eliminated and information that the output of U2 is connected to the input of U4 via connection n0 is hashed or stored so when the cell is instantiated correct connections can be generated.

Buffer U5 represents a condition where the input of buffer U5 is connected to a respective I/O port of the cell. Buffer U5 and connection n2 are eliminated and information that input port c is connected to the input of U6 is hashed or stored so when the cell is instantiated correct connections can be generated.

Buffer U8 represents a condition where the output of buffer U8 is connected to a respective I/O port of the cell. Buffer U8 and connection n3 are eliminated and information that output port D is connected to the output of U7 is hashed or stored so when the cell is instantiated correct connections can be generated.

Buffer U9 represents a condition where the input of buffer U9 is connected to a power supply the output of buffer U9 is connected to an output port of the cell. Buffer U9 is eliminated and information that ties a reference signal to the output port is hashed or stored so when the cell is instantiated correct connections can be generated.

FIG. 5 is schematic diagram illustrating an example embodiment of a second cell-level circuit model where a cell has a single input port and two output ports. As shown in FIG. 5, buffer U2 is not deleted since it separates the two output ports of the cell. Accordingly, there is no modification of the cell information for a cell with this circuit architecture even though both output ports are logically equivalent.

The modifications exemplified above in association with FIGS. 4A, 4B and 5 are representative of intra-cell modifications that are performed by intra-cell modification logic 323 (FIG. 3) on leaf cells. Otherwise, when the circuit model generator encounters a non-leaf cell the circuit model generator performs a series of recursive calls to strip cell information from the original circuit model.

Thereafter, circuit model generator 120 performs a series of modifications on the various modified cells to ensure that the cell to cell interconnectivity is modeled appropriately. For example, connections at the boundary of a current cell need to be reconnected by reviewing the hashed or buffered information.

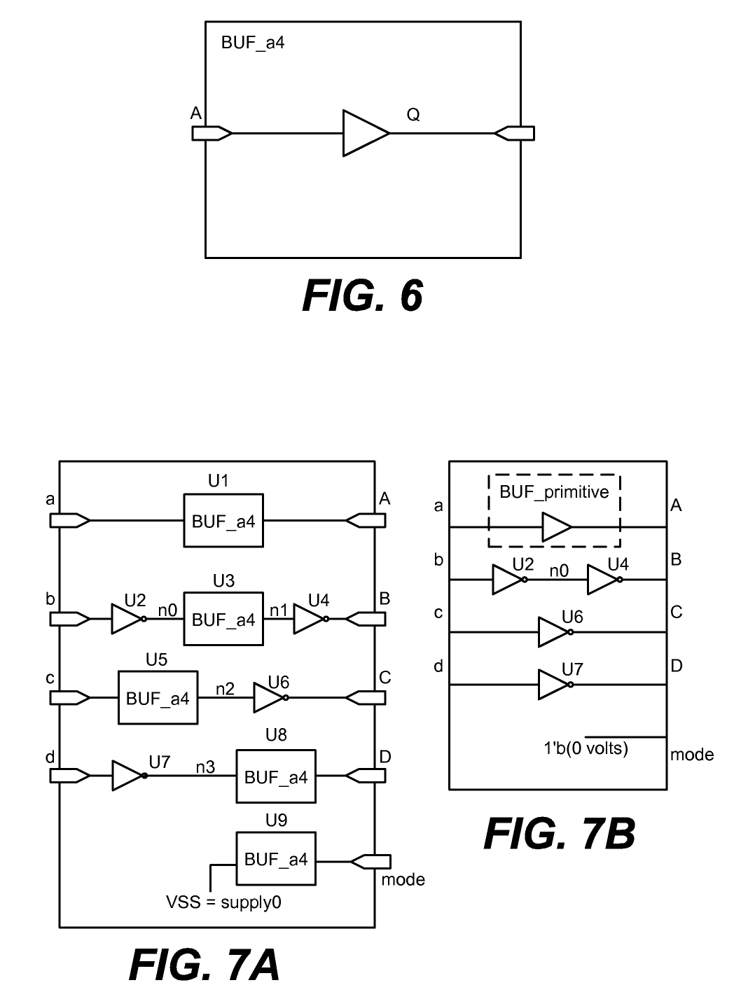

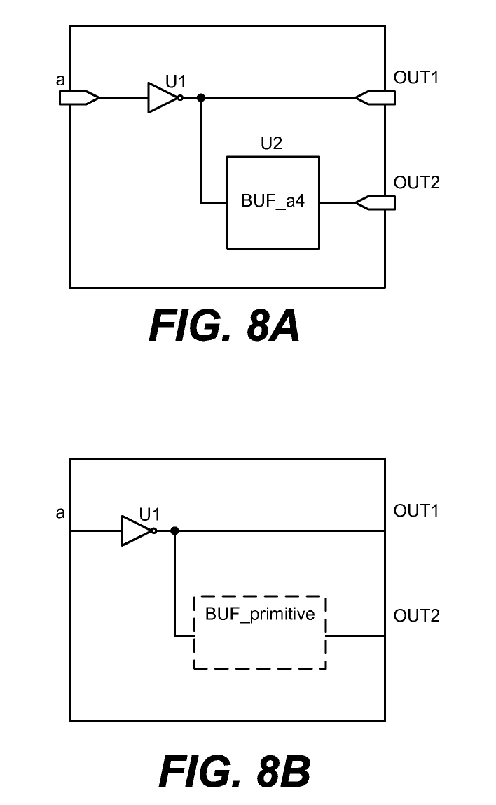

FIG. 6 illustrates that a cell abstraction labeled “BUF_a4” is generated from a single buffer primitive. A buffer primitive includes information identifying the input and the output to the modeled buffer. FIGS. 7A, 7B, 8A, and 8B reveal various conditional modifications to the cell models.

In FIG. 7A, buffer U1 represents a condition where both the input and the output of buffer U1 are connected to respective I/O ports of the cell and the cell is at the top-level of the hierarchical circuit design, two ports with different names will not be tied together, consequently buffer U1 is replaced by a buffer primitive to separate input a from output A. As also shown in FIG. 7A, buffer U3 represents a condition where both the input and the output of buffer U3 are not connected to respective I/O ports of the cell. Buffer U3 and connection n1 are eliminated and information that the output of U2 is connected to the input of U4 via connection n0 is hashed or stored as shown in FIGS. 7A & 7B.

Buffer U5 represents a condition where the input of buffer U5 is connected to a respective I/O port of the cell. Buffer U5 and connection n2 are eliminated and information that input port c is connected to the input of U6 is hashed or stored as shown in FIGS. 7A & 7B.

Buffer U8 represents a condition where the output of buffer U8 is connected to a respective I/O port of the cell. Buffer U8 and connection n3 are eliminated and information that output port D is connected to the output of U7 is hashed or stored as indicated in FIGS. 7A & 7B.

Buffer U9 represents a condition where the input of buffer U9 is connected to a power supply the output of buffer U9 is connected to an output port of the cell. Buffer U9 is eliminated and information that ties a reference signal to the output port is hashed or stored as shown in FIGS. 7A & 7B.

FIGS. 8A & 8B are schematic diagrams illustrating an example embodiment of a cell-level circuit model where a cell has a single input port and two output ports. As shown in FIGS. 8A & 8B, buffer U2 is replaced with a buffer primitive since it separates the two output ports of the cell.

The foregoing description has been presented for purposes of illustration and description. It is not intended to be exhaustive or to limit the scope of the claims to the precise forms disclosed. Modifications or variations are possible in light of the above teachings. The embodiments discussed, however, were chosen and described to enable one of ordinary skill to utilize various embodiments of the present systems and methods for analyzing a circuit model. All such modifications and variations are within the scope of the appended claims when interpreted in accordance with the breadth to which they are fairly and legally entitled.

What is claimed is:

1. A method for analyzing a circuit model, comprising:
selecting a cell from a circuit model to identify a cell under test, the cell under test including information that defines the cell under test;
identifying when the information indicates that the cell under test is a leaf cell;
when the cell under test is a leaf cell, applying a first set of conditional modifications to generate a modified cell definition; and
recursively applying a second set of conditional modifications to generate a modified circuit model responsive to the modified cell definition.

2. The method of claim 1, wherein a cell under test includes information regarding connectivity.

3. The method of claim 1, wherein a cell under test includes information regarding internal components.

4. The method of claim 1, wherein identifying when the information indicates that the cell under test is a leaf cell comprises identifying the presence of a primitive.

5. The method of claim 4, wherein the primitive includes a circuit with a component selected from the group consisting of amplifier, inverter, and logic gate.

6. The method of claim 1, wherein identifying when the information indicates that the cell under test is a leaf cell further comprises:
identifying the presence of a circuit that includes a series coupled chain of inverters; and
applying the first set of conditional modifications to generate a modified cell definition further comprises eliminating the chain of inverters while preserving the polarity of a signal propagated along the modeled chain.

7. A program embodied in a computer-readable medium for automatically generating a modified circuit model, the program comprising:
logic configured to select a cell from a circuit model to identify a cell under test, the cell under test including information that defines the cell under test;
logic configured to identify when the information indicates that the cell under test is a leaf cell, when the cell under test is a leaf cell branching to logic configured to apply a first set of conditional modifications to generate a modified cell definition; and
recursive logic configured to apply a second set of conditional modifications to generate a modified circuit model.

8. The program of claim 7, wherein the logic configured to select a cell under test receives information regarding interface connectivity and internal connectivity.

9. The program of claim 7, wherein the logic configured to select a cell under test receives information regarding internal components.

10. The program of claim 7, wherein the logic configured to identify when the information indicates that the cell under test is a leaf cell comprises identifying the presence of a primitive.

11. The program of claim 11, wherein the primitive includes a circuit with a component selected from the group consisting of amplifier, inverter, and logic gate.

12. The program of claim 7, wherein the logic configured to identify when the information indicates that the cell under test is a leaf cell further identifies when a circuit in the cell includes a chain of series coupled inverters and wherein in response, the modified cell definition no longer includes an even number of inverters from the chain of series coupled inverters to preserve the polarity of a signal propagated along the modeled chain.

13. A circuit model generation system, comprising:
a memory containing a hierarchical model of a device under test, the hierarchical model comprising a plurality of cells; and
a processor configured to execute logic that selects a cell from a circuit model to identify a cell under test, the cell under test including information that defines the cell under test, execute logic that identifies when the information indicates that the cell under test is a leaf cell, when the cell under test is a leaf cell, execute logic that applies a first set of conditional modifications to generate a modified cell definition and execute logic that applies a second set of conditional modifications to generate a modified circuit model.

14. The system of claim 13, wherein the cell under test includes information regarding interface connectivity.

15. The system of claim 13, wherein the cell under test includes information regarding internal connectivity.

16. The system of claim 13, wherein the cell under test includes information regarding internal components.

17. The system of claim 13, wherein the processor identifies when the information indicates that the cell under test is a leaf cell by identifying the presence of a primitive.

18. The system of claim 17, wherein the primitive includes a circuit with a component selected from the group consisting of amplifier, inverter, and logic gate.

19. The system of claim 17, wherein the processor identifies when the information indicates that the cell under test includes a series coupled chain of inverters.

20. The system of claim 19, wherein the first set of conditional modifications generates a modified cell definition that removes an even number of inverters from the series coupled chain of inverters.
